(19) United States
(12) Patent Application Publication
(10) Pub. No.: US 2008/0214091 A1
(43) Pub. Date: Sep. 4, 2008

(54) Sanding Apparatus

(76) Inventor: Miksa Marton, Windsor (CA)

Correspondence Address: FILDES & OUTLAND, 20916 Mack Avenue, Ste. 2, Grosse Pointe Woods, MI, 48236, US

(21) Appl. No.: 10/587,475

(22) PCT Filed: Feb. 1, 2005
(86) PCT No.: PCT/IB2005/000242

§ 371 Date: Jul. 26, 2006

Related U.S. Application Data
(60) Provisional application No. 60/541,218, filed on Feb. 2, 2004.
(60) Provisional application No. 60/545,058, filed on Feb. 17, 2004.
(60) Provisional application No. 60/560,293, filed on Apr. 7, 2004.

(51) Int. Cl. B24B 23/00; B24B 1/00; G01D 13/00

(52) U.S. Cl. 451/28; 451/359; 33/645

(57) ABSTRACT

A sanding apparatus for sanding a support surface includes an elongated frame having a handle end and a work end. The handle end is arranged for operator control and the work end is adapted for connection to a working device. The sanding apparatus also includes a stabilizer member adapted to contact and grip the support surface. The stabilizer member is disposed between the handle end and the work end. The stabilizer member prevents the sanding apparatus from pulling away from an operator during use.

### TECHNICAL FIELD

This invention relates to a sanding apparatus, and more particularly to an improved sanding apparatus usable for a wide variety of sanding and grinding applications.

### BACKGROUND OF THE INVENTION

It is known in the art relating to sanders that conventional sanders have many shortcomings. First, it is known that when sanding or grinding a surface, especially when using a coarse and/or wide disc, that the sanding machine undesirably pulls away from the operator across the surface. The rotational speed of the sanding/grinding disc combined with the friction between the sanding/grinding disc and the surface cause the sanding machine to forcedly move in a sideways direction. This effect has a negative impact on operator control of the sanding machine and therefore leads to longer task completion times and poorer quality. Second, it is known that it is difficult to change a pad located underneath a sander because it is awkward to flip and stabilize the machine to access the pad. Further, it is known that when sanding a floor, sanders are not capable of sanding close to walls without causing damage to the walls. Usually a drum sander is used to sand a floor and it cannot be brought close to a wall during operation. This undesirably makes it necessary to use a separate tool to sand the edges of the floor.

### SUMMARY OF THE INVENTION

The present invention provides a sanding apparatus that solves the aforementioned disadvantages of conventional sanders and that can be used to sand a variety of surfaces. The present sanding apparatus does not walk or pull away from the operator. Further, it is easy to change the sanding/abrasive pad that may be used with the present sanding apparatus. Moreover, the present sanding apparatus is capable of sanding surfaces adjacent to walls without damaging the walls.

More particularly, a sanding apparatus for sanding a support surface in accordance with the present invention includes an elongated frame having a handle end and a work end. The handle end is arranged for operator control and the work end is adapted for connection to a working device. The sanding apparatus also includes a stabilizer member adapted to contact and grip the support surface. The stabilizer member is disposed between the handle end and the work end and prevents the sanding apparatus from pulling away from an operator during use.

Optionally, the stabilizer member may include at least one circular rotating member mounted thereon. The circular rotating member may include a peripherally disposed friction layer. The friction layer may be a rubber-like material. The circular rotating member may also be weighted. Further, the stabilizer member may include a plurality of adjacent circular rotating members and anti-friction washers separating the circular rotating members.

The elongated frame may be universally rotatable about the stabilizer member. A working device may be operatively, pivotally connected to the work end of the elongated frame and a locking member may be included for locking the working device into an operative position on the elongated frame. The handle end may include a handle, the handle being universally rotatable about the elongated frame. The working device may include a housing and at least one side-wheel extendedly mounted to the housing. The working device also may include a backing pad being of a ring-like shape. The elongated frame may be at least partially tubular to allow for communication of sanding waste.

Additionally, the sanding apparatus may include a pair of receivers disposed at the work end of the elongated frame and a stand. The stand may include two elongated engagement members receivable in the receivers, the engagement members being generally parallel to each other. The stand may also include a leg extending from each engagement member generally perpendicular to the engagement members, each of the legs being disposed generally centrally along the engagement member from which it extends. The stand may further include a brace member connected to the legs at ends of the legs.

In a specific embodiment of the present invention, a sanding apparatus for sanding a support surface includes an elongated frame having a handle end and a work end. The sanding apparatus further includes a working device including a housing, two opposing pivot ears extending from the housing, at least one side-wheel extendedly mounted to the housing, a motor mounted on the housing, and a backing pad operatively connected to the motor. The working device is operatively connected to the work end of the elongated frame by the pivot ears. The handle end of the frame includes a handle and controls for controlling the working device. The frame further includes a stabilizer member adapted to contact and grip the support surface, the stabilizer member being disposed between the handle end and the work end of the frame. The stabilizer member includes at least one circular rotating member mounted thereon.

A method for sanding a support surface includes the step of providing a sanding apparatus. The sanding apparatus includes an elongated frame having a handle end and a work end. The handle end is arranged for operator control. The work end is adapted for connection to a working device. The sanding apparatus also includes a stabilizer member adapted to contact and grip the support surface. The stabilizer member is disposed between the handle end and the work end of the frame and prevents the sanding apparatus from pulling away from an operator during use. Optionally, the stabilizer member may include a circular rotating member mounted thereon. Also, the circular rotating member may be weighted.

An alignment tool for aligning an abrasive pad on a sanding apparatus including a rotatable backing pad is disclosed. The tool includes a T-shaped handle and three elongated locating pins. The locating pins extend from a surface of the T-shaped handle and are spacedly disposed on the handle. The locating pins are insertable into apertures in the abrasive pad and backing pad.

These and other features and advantages of the invention will be more fully understood from the following detailed description of the invention taken together with the accompanying drawings.

### BRIEF DESCRIPTION OF THE DRAWINGS

In the drawings:

FIG. 1 is a perspective view of a first embodiment of a sanding apparatus in accordance with the present invention placed on a support surface;

FIG. 2 is a perspective view of the sanding apparatus of FIG. 1 illustrating rotation of an elongated frame of the sanding apparatus about a stabilizer member of the sanding apparatus;

FIG. 3A is a perspective view of the sanding apparatus of FIG. 1 in combination with a stand;

FIG. 3B is a perspective view of FIG. 3A illustrating the sanding apparatus stably supported and held above the support surface by the stand;

FIG. 3C is a perspective view of the stand of FIGS. 3A and 3B;

FIG. 4 is a perspective view of a second embodiment of a sanding apparatus in accordance with the present invention placed on a support surface;

FIG. 5 is a plan view of the sanding apparatus of FIG. 4 sanding along a wall adjacent the support surface;

FIG. 6 is a perspective view of a handle end of the sanding apparatus of FIG. 4 illustrating rotation of a handle located at the handle end;

FIG. 7 is a perspective view of the sanding apparatus of FIG. 4 illustrating rotation of a working device of the sanding apparatus about pivot ears;

FIG. 8 is another perspective view of the sanding apparatus of FIG. 4 illustrating rotation of the working device to allow easy access to a sanding pad mounted on the working device; and

FIG. 9 is a perspective view of the sanding apparatus of FIG. 4 illustrating alignment of a sanding pad with a backing pad of the working device with the use of an alignment tool.

### DETAILED DESCRIPTION OF THE INVENTION

Referring now to the drawings in detail, numeral 10 generally indicates a sanding apparatus for sanding a support surface. The sanding apparatus of the present invention provides for increased operator control such that the present sanding apparatus does not walk or pull away from the operator. The sanding apparatus also allows for a sanding/abrasive pad operatively mounted to a working device of the sanding apparatus to be easily replaced. Furthermore, the sanding apparatus is capable of easily sanding surfaces adjacent to walls without damaging the walls.

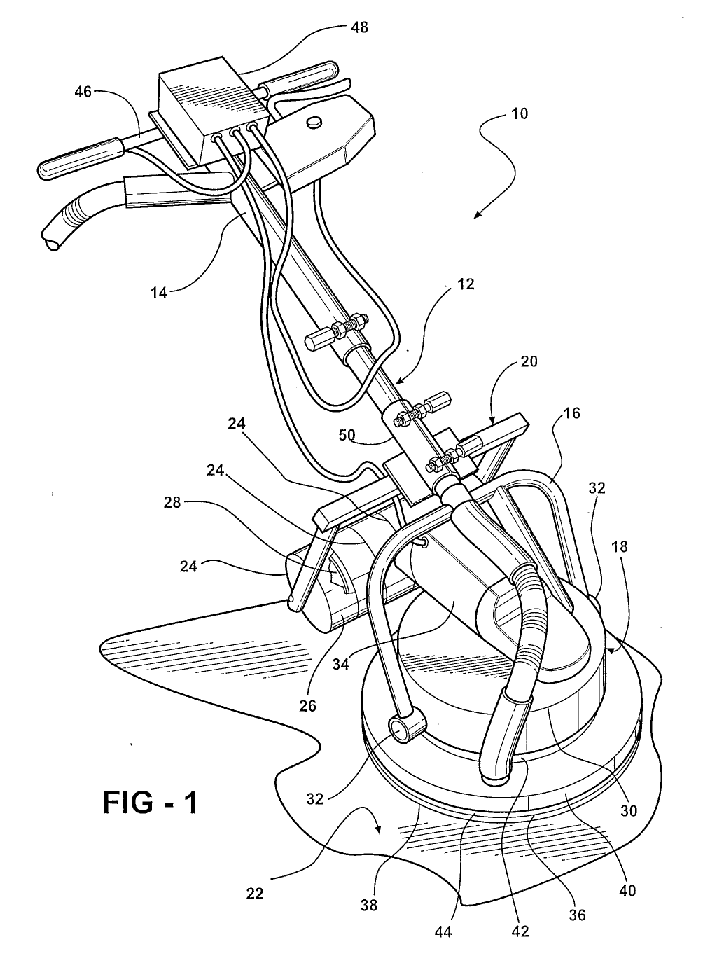

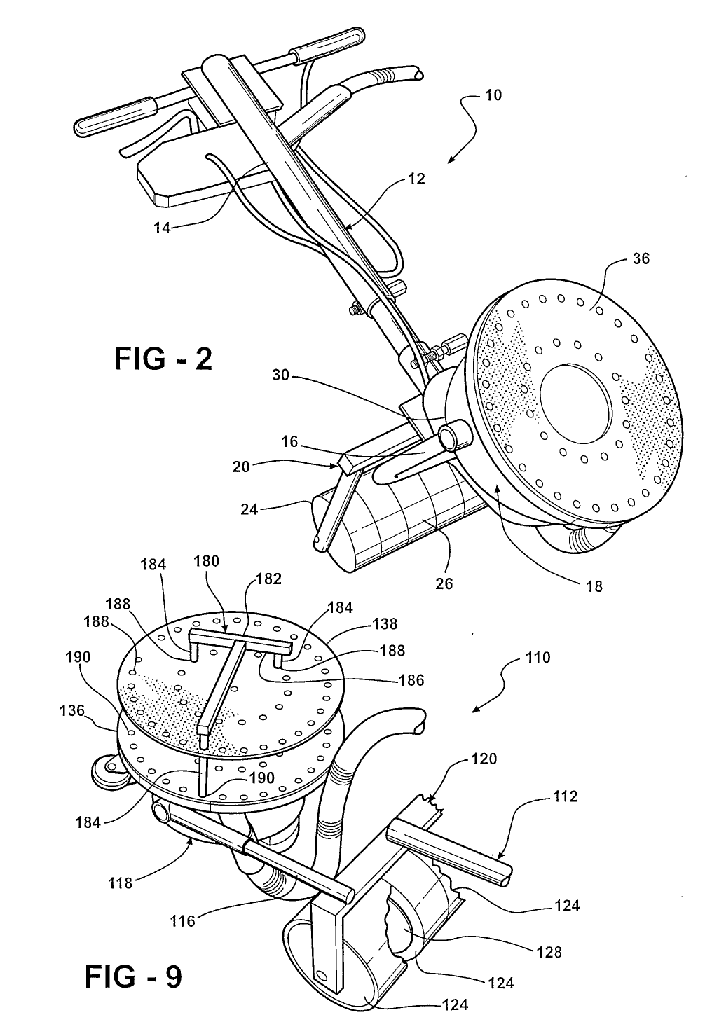

Referring to FIGS. 1 and 2, a first embodiment of a sanding apparatus 10 in accordance with the present invention includes an elongated frame 12 having a handle end 14 and a work end 16. The handle end 14 is arranged for operator control and the work end 16 is adapted for connection to a working device 18. The working device 18 may be a sanding device, a grinding device, or similar abrasive device capable of sanding and/or grinding a surface, such as an orbital sander, a circular sander, or a dual action sander. The working device 18 may use any type of abrasive pad, disc, wheel, etc., may or may not use water, and may be driven by electricity or pressurized air. The sanding apparatus 10 also includes a stabilizer member 20 adapted to contact and grip a support surface 22. The support surface 22 may be a floor, marble, stone, or similar. The stabilizer member 20 is disposed between the handle end 14 and the work end 16 and prevents the sanding apparatus 10 from pulling away from an operator during use. Preferably, the stabilizer member 20 may be disposed closer to the work end 16 than the handle end 14. Also, the elongated frame 12 may be at least partially tubular to allow for communication of sanding waste created by the working device 18 during use.

In this embodiment of the sanding apparatus 10, the stabilizer member 20 may include at least one circular rotating member 24 mounted thereon. The circular rotating member(s) 24 may be mounted on the stabilizer member 24 by an axle, opposing pins, or other similar suitable mount. The circular rotating member(s) 24 may be wheels, rollers, or similar, may have any suitable diameter and width, and may be aided in rotation by bearings or similar. The circular rotating member(s) 24 may include a peripheral friction layer 26. The friction layer 26 may be a rubber-like material or similar material that aids the circular rotating member 24 in gripping the support surface 22 without damaging the surface. The circular rotating member(s) 24 may slide from side to side as well as rotate to allow an operator to move the sanding apparatus 10 in any desired direction. The circular rotating member(s) 24 also allow the sanding apparatus 10 to partially move off an edge of a support surface 22 without the sanding apparatus 10 tilting towards one of its sides.

The circular rotating member(s) 24 may also be weighted. For example, the circular rotating member(s) 24 may be weighted to a total weight of 10 pounds, which is suitable for light sanding applications, or the circular rotating member(s) 24 may be weighted to a total weight of 125 pounds, which is suitable for heavy grinding applications. Generally, the lighter the sanding/grinding application, the less weight that is needed and the heavier the sanding/grinding application, the more weight that is needed. In any event, the circular rotating member(s) 24 may be weighted to any desired weight.

Further, the stabilizer member 20 may include a plurality of adjacent circular rotating members 24 and anti-friction washers 28 separating the circular rotating members 24. The anti-friction washers 28 may be constructed of a polycarbon material, Teflon®, or similar. The use of a plurality of adjacent circular rotating members 24 allows for differential rotation of the circular rotating members, enabling easier turning of the sanding apparatus 10 by an operator. The anti-friction washers 28 enhance the differential rotation of the circular rotating members.

The working device 18 may be operatively, pivotally connected to the work end 16 of the elongated frame 12. The working device 18 may include a housing 30 that may function both as a suction housing and a gear housing. The housing 30 may be constructed of aluminum or any other similar, suitably rigid material. Pivot ears 32 extending from the housing 30 may allow for the pivotal connection of the working device 18 to the elongated frame 12. The working device 18 may also include a motor 34 mounted on the housing 30 and a backing pad 36 operatively, drivingly connected to the motor 34 through the gear housing 30. The backing pad 36 allows for the mounting of a sanding/abrasive pad 38 thereon. A guide ring 40, made of a hard steel material or similar, may be mounted to an end 42 of the housing 30 opposite the motor 34. The guide ring 40 extends to the edge 44 of the backing pad 36, thereby circumscribing the backing pad and allowing the working device 18 to come within approximately one millimeter of a wall (not shown) adjacent the support surface 22 being sanded without causing damage to the wall and without requiring subsequent edge sanding.

The backing pad 36 of the working device 18 may be of a ring-like shape, as shown in FIG. 2. For example, a center section of the backing pad 36 may be removed so that the backing pad has a shape similar to the cross-sectional shape of a doughnut. If the backing pad has a 16-inch diameter, a 7½-inch diameter circle may be removed from the center of the pad. Likewise, the same portion of the abrasive/sanding pad 38 may be removed. This backing pad design prevents the sanding apparatus from undesirably marking a support surface 22 with circular marks.

The handle end 14 of the elongated frame 12 may include a handle 46. The handle 46 may be universally rotatable about the elongated frame 12, allowing the handle to be rotated 360 degrees about the elongated frame. This is useful, for example, when sanding along an edge of a wall because the handle 46 may contact the wall when in a horizontal orientation but not while in a vertical orientation. An operator therefore can rotate the handle 46 towards a vertical orientation when approaching and sanding along the wall, and then move the handle back to a standard horizontal orientation afterwards. The construction of the frame 12 also provides easy assembly and disassembly for shipping, transporting, and storage.

The handle end 14 may also include controls 48 such as a speed reducer, a master on/off switch, and a safety shutoff device. The speed reducer may be a rheostat and may allow for the adjustment of the speed of the motor 34 and therefore the speed of the backing pad 36 and sanding/abrasive pad 38. It may be desirable to adjust the speed of the motor 34 depending on the sanding/grinding application, i.e., on the type of surface 22 being sanded/grinded.

The elongated frame 12 may be universally rotatable about the stabilizer member 20. For example, the stabilizer member 20 may be secured to the elongated frame 12 by a slip joint 50, a clamp, a lock pin, adjustable collar, or similar. Loosening the slip joint 50 allows the elongated frame 12 to be rotated about the slip joint 50. This aids an operator when mounting, removing, or changing a sanding/abrasive pad 38. To change a sanding pad 38, an operator loosens the slip joint 50 holding the stabilizer member 20 to the elongated frame 12. The operator then pushes down on the handle end 14 to lift the work end 16 of the sanding apparatus 10 off the support surface 22. The operator then rotates the handle end 14 of the frame 180 degrees, thereby flipping the work end 16 so that the sanding pad 38 underneath the housing 30 is easily accessible. The operator may then add an abrasive pad 38 to the backing pad 36, remove an abrasive pad from the backing pad, or swap the abrasive pad attached to the backing pad for another abrasive pad. After changing the abrasive pad 38, the operator rotates the handle end 14 of the frame 180 degrees, allows the work end 16 of the sanding apparatus 10 to rest on the support surface 22, and tightens the slip joint 50 to resecure the stabilizer member 20 to the frame 12.

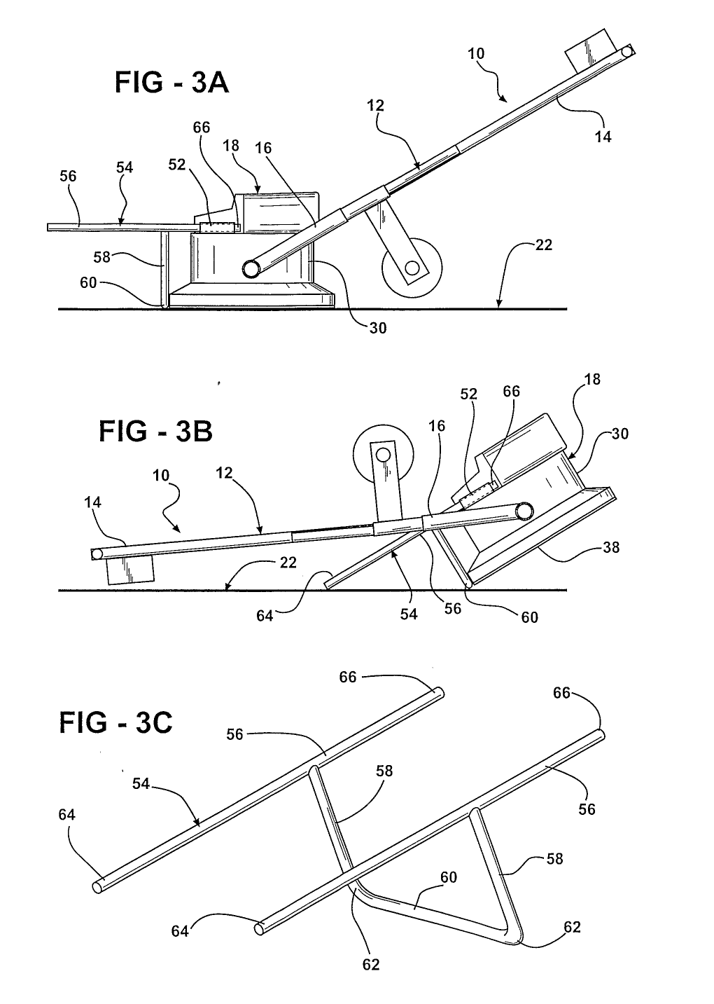

Turning now to FIGS. 3A through 3C, the sanding apparatus 10 may include a pair of receivers 52, such as hollow pipes or similar, disposed at the work end 16 of the elongated frame 12. The receivers 52 may be mounted to the housing 30 of the working device 18. The sanding apparatus 10 may also include a stand 54. The stand 54 may include two elongated engagement members 56 receivable in the receivers 52, the engagement members 56 being generally parallel to each other. The stand 54 may also include a leg 58 extending from each engagement member 56 generally perpendicular to the engagement members 56, each of the legs 58 being disposed generally centrally along the engagement member 56 from which it extends. Each leg 58 may be fixedly connected to corresponding engagement member 56, such as by welding or other mechanical connection, or each leg may be integral with the corresponding engagement member. The stand 54 may further include a base member 60 connected to the legs 58 at ends 62 of the legs. The base member 60 may be an elongated cross pipe, may be fixedly connected to the legs, such as by welding or other mechanical connection, or may be integral with the legs. The base member 60 extends between the legs 58 and may also extend beyond the area between the legs. A resilient covering (not shown) such as rubber tubing may cover the outer surface of the base member 60 as well as ends 64 of the engagement members 56. The stand 54 functions as a fulcrum and aids an operator in accessing the underside of the working device 18 of the sanding apparatus 10 to change the sanding/abrasive pad 38 located on the bottom of working device.

In the embodiment illustrated in FIGS. 3A through 3C, the inner diameters of the receivers 52 are larger than the diameters of the engagement members 56. The receivers 52 are mounted generally parallel to each other and at a distance from each other equal to the distance between the engagement members 56 of the stand 54. The receivers 52 receive corresponding ends 66 of the engagement members 56 to engage the sanding apparatus 10 with the stand 54. When the sanding apparatus 10 is engaged with the stand 54, the stand 54 is positioned opposite of the handle end 14 of the sanding apparatus.

Once the engagement members 56 are inserted into the receivers to engage the stand 54 with the sanding apparatus 10, the operator may lift up on the handle end 14 of the sanding apparatus. This forces the base member 60 against the support surface 22, and friction between the resilient covering of the base member and the support surface prevents the stand 54 from moving. The sanding apparatus 10 and engaged stand 54 rotate about the base member 60. The operator continues to lift up on the handle end 14 of the sanding apparatus 10 until the free ends 64 of the engagement members 56 contact and rest against the support surface 22. In this position, the center of gravity of the system is located at a point between the base member 60 and the resting ends 64 of the engagement members 56 such that the sanding apparatus 10 is stably supported and held above the support surface 22 (see FIG. 3B). The operator may then safely and easily change the sanding pad 38 attached on the underside of the working device 18 of the sanding apparatus 10.

After attaching a new sanding pad 38 to the sanding apparatus 10, the operator then pulls down on the handle end 14 to bring the sanding apparatus back down to the support surface 22. The operator may then disengage the stand 54 from the sanding apparatus 10 and store the stand until the sanding pad 38 needs to be changed again.

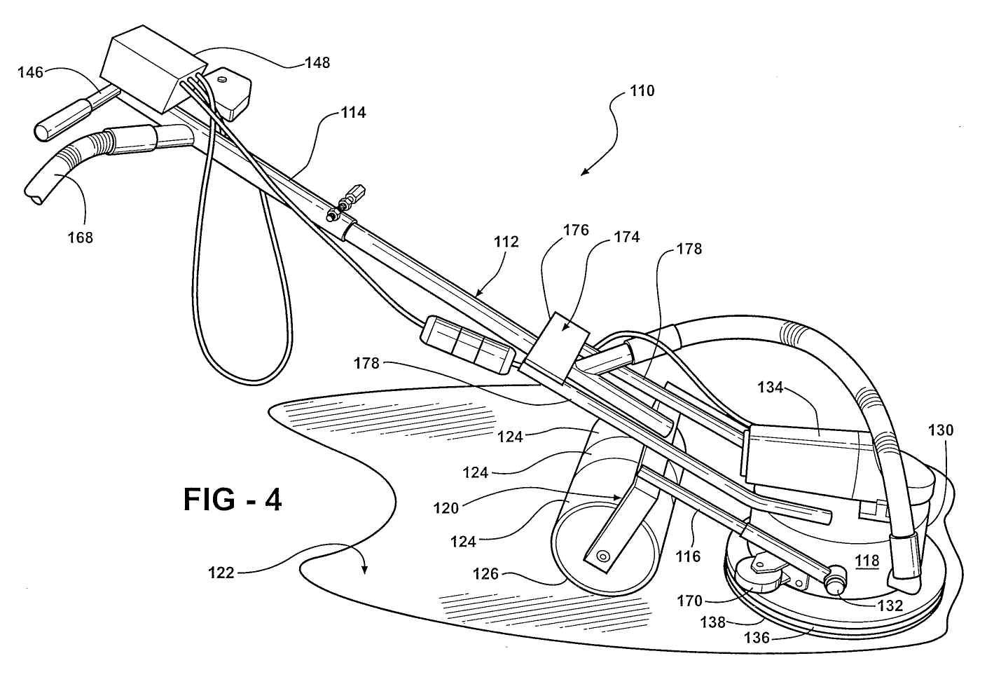

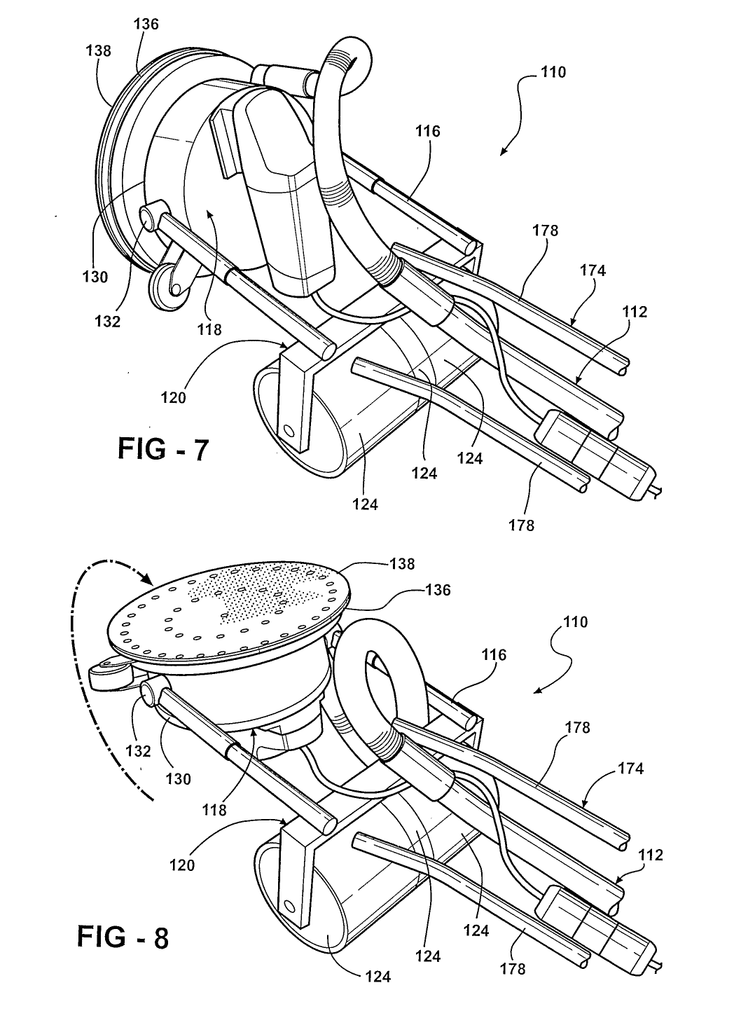

In a second embodiment of the present invention, as shown in FIGS. 4 through 9, a sanding apparatus 110 includes an elongated frame 112 having a handle end 114 and, a work end 116. The handle end 114 is arranged for operator control and the work end 116 is adapted for connection to a working device 118. The working device 118 may be a sanding device, a grinding device, or similar abrasive device capable of sanding and/or grinding a surface. The sanding apparatus 110 also includes a stabilizer member 120 adapted to contact and grip a support surface 122. The stabilizer member 120 is disposed between the handle end 114 and the work end 116 and prevents the sanding apparatus 110 from pulling away from an operator during use. Preferably, the stabilizer member 120 may be disposed closer to the work end 116 than the handle end 114. Also, the elongated frame 112 may be at least partially tubular to allow for communication of sanding waste created by the working device 118 during use.

The stabilizer member 120 may include at least one circular rotating member 124 mounted thereon. The circular rotating member(s) 124 may be mounted on the stabilizer member 120 by an axle, opposing pins, or other similar suitable mounting means. The circular rotating member(s) 124 may be wheels, rollers, or similar, may have any suitable diameter and width, and may be aided in rotation by bearings or similar. The circular rotating member(s) 124 may include a peripherally disposed friction layer 126. The friction layer 126 may be a rubber-like material or similar material that aids the circular rotating member 124 in gripping the support surface 122 without damaging the surface. The circular rotating member(s) 124 may also be weighted to any desired weight as described in the first embodiment.

Further, the stabilizer member 120 may include a plurality of adjacent circular rotating members 124 and anti-friction washers 128 (see FIG. 9) separating the circular rotating members 124. The anti-friction washers 128 have the same features and functions as described in the first embodiment. As shown by example in the second embodiment, the stabilizer member 120 of the sanding apparatus 110 includes three circular rotating members 124. Two of the circular rotating members 124 may be wider than the third circular friction member 124. The wider circular rotating members 124 are disposed on either side of the narrower circular rotating member 124. The anti-friction washers 128 are disposed between the circular rotating members 124. In this embodiment, when an operator turns the sanding apparatus 110 to the left or right, the wider, outer circular rotating members 124 rotate in opposite directions (i.e., one clockwise, the other counter-clockwise) and the narrower, inner circular rotating member 124 rotates very little. This allows the operator to easily move and turn the sanding apparatus 110 while at the same time assures that the movement of the sanding apparatus is controlled and that the sanding apparatus does not pull or walk away from the operator.

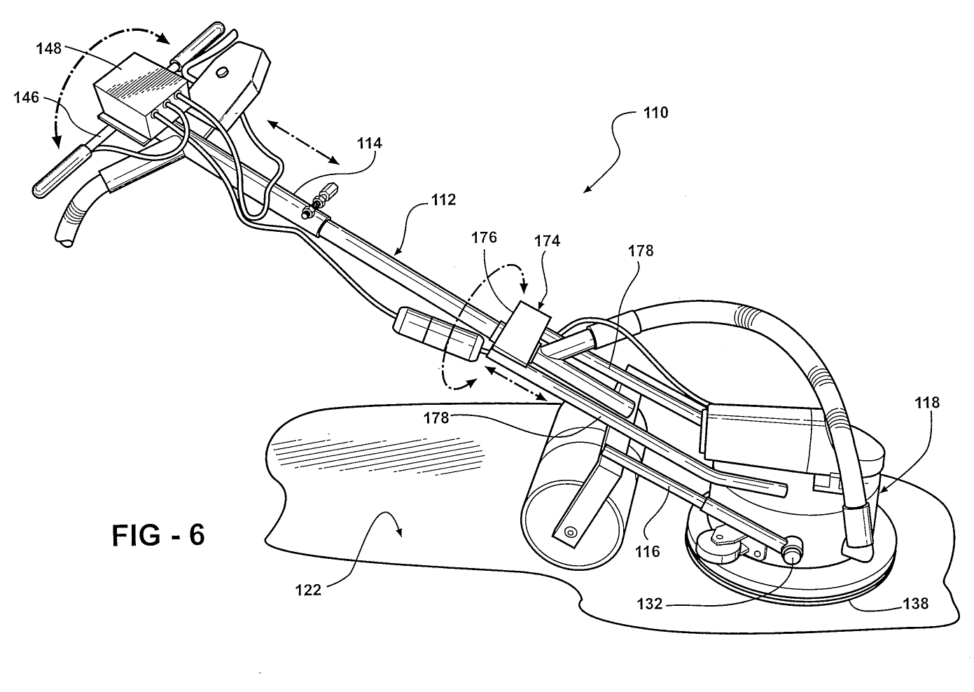

The handle end 114 of the elongated frame 112 may include a handle 146. The handle 146 may be universally rotatable about the elongated frame 112, allowing the handle to be rotated 360 degrees about the elongated frame (see FIG. 6). This is useful, for example, when sanding along an edge of a wall because the handle 146 may contact the wall when in a horizontal orientation but not while in a vertical orientation. An operator therefore can rotate the handle 146 towards a vertical orientation when approaching and sanding along the wall, and then move the handle back to a standard horizontal orientation afterwards. The handle 146 may also be adjusted along the length of the frame 112 to allow the handle to be lengthened and shortened. The handle 146 is therefore fully adjustable for each individual operator. The handle end 114 may further include controls 148 such as a speed reducer, a master on/off switch, and a safety shutoff device as described in the first embodiment.

The working device 118 may be operatively, pivotally connected to the work end 116 of the elongated frame 112. The working device 118 may include a housing 130 that may function both as a suction housing and a gear housing. The housing 130 may be constructed of aluminum or any other similar, suitable rigid material. Pivot ears 132 extending from the housing 130 may allow for the pivotal connection of the working device 118 to the elongated frame 112. The housing 130 is rotatable about the pivot ears 132 as described in more detail below. A suction means (not shown), such as a vacuum or similar, may be operatively connected to the housing 130, for example by tubing 168 or similar. The working device 118 may also include a motor 134 mounted on the housing 130 and a backing pad 136 operatively, drivingly connected to the motor 134 through the gear housing 130. The backing pad 136 allows for the mounting of a sanding/abrasive pad 138 thereon.

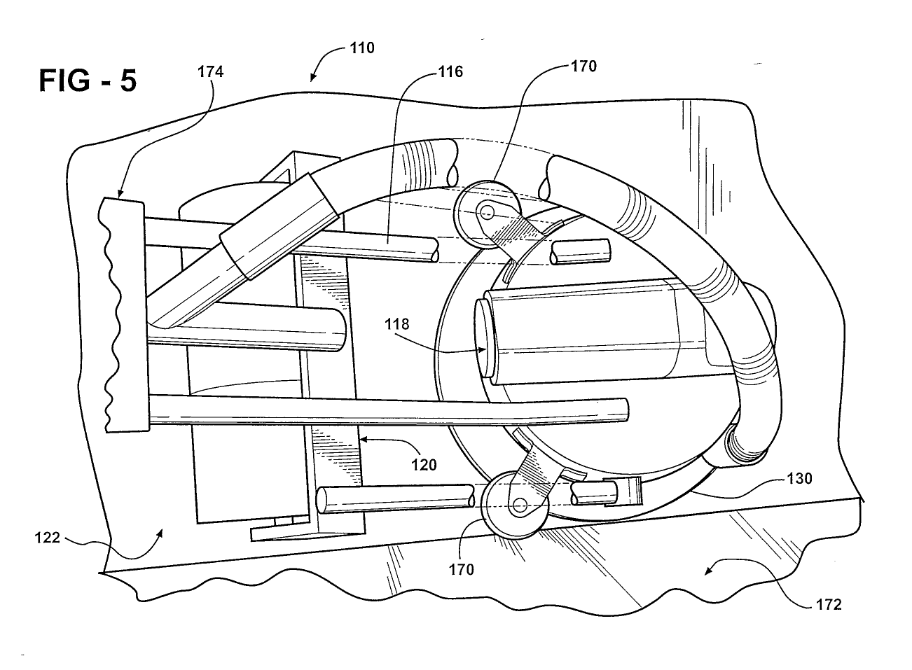

The housing 130 may also include at least one side-wheel 170 extendedly mounted to the housing 130. For example, in this embodiment the housing 130 includes two side-wheels 170. As shown in FIG. 5, each side-wheel 170 is oriented such that it may travel along a wall 172 adjacent to the support surface 122. Each side-wheel 170 thereby prevents the housing 130 and/or the sanding pad 138 from touching the wall 172 while at the same time allowing the sanding pad to reach the edge of a sanding surface adjacent to the wall. Each side-wheel 170 may be adjustably mounted on the housing 130 such that each side-wheel may be moved and temporarily fixed at various positions along the housing.

The sanding apparatus 110 may further include a locking member 174 for locking the working device 118 into an operative position on the elongated frame 112. For example, as shown in FIG. 4, the locking member 174 may include a crossbar 176 that preferably may be shorter in length than the diameter of the housing 130. The locking member 174 may also include an arm 178 extending from each end of the crossbar 176 towards the work end 116 of the frame 112. The arms 178 are engagable with the housing 130 to prevent the working device 118 from rotating about the pivot ears 132. The locking member 174 may be slidably mounted to the frame 112 and may be rotatable thereabout for releasing and securing the locking member (see FIG. 6). Alternatively, the locking member 174 may be any other suitable locking device such as a locking clamp, locking nut, or similar, disposed about the pivot ears 132. The locking member 174 secures the working device 118 so that if the operator tilts the work end 116 of the sanding apparatus 110 away from the support surface 122, the working device 118 cannot rotate and therefore does not contact the support surface at an angle, which would cause the sanding/abrasive pad 138 to cut into the support surface. The locking member 174 thereby prevents the working device 118 from rotating away from the operating position until it is necessary to change the sanding/abrasive pad 138.

The ease with which an operator may change a sanding/abrasive pad 138 mounted on the working device 118 of the present invention is illustrated by the following description and with reference to FIGS. 6 through 9. In order to change the sanding pad 138, the operator first shuts off the motor, if running, to bring the sanding pad 138 and the sanding apparatus 110 to rest. The operator then slides the locking member 174 towards the handle end 114 of the frame 112, thereby releasing the ends of the locking member arms 178 from contact with the housing 130. Once the locking member 174 has been slid far enough towards the handle end 114 such that the locking member arms 178 are free to rotate about the frame 112, the operator rotates the locking member 174 about the frame. In this orientation, one of the locking member arms 178 may rest against the stabilizer member 120, preventing the locking member 174 from moving.

After moving the locking member 174, the operator pushes down on the handle end 114 and/or the elongated frame 112, thereby raising the working device 118 above the support surface 122. The working device 118, being in a metastable position, rotates about the pivot ears 132 approximately 180 degrees such that the bottom of the working device moves from facing the support surface 122 to facing upwards. The operator may use his or her hand to restrict the rotation of the working device 118 so that the working device may be slowly moved from its metastable position to a stable position. The operator may then raise the handle end 114 and/or the elongated frame 112 until the rotated working device 118 rests against the support surface 122. The sanding pad 138 mounted on the backing pad 136 is now facing away from the support surface 122 and is accessible to the operator.

At this time, the operator may remove the sanding pad 138 and replace it with another sanding pad by mounting another sanding pad on the backing pad 136 of the sanding apparatus 110. After changing the sanding pad 138, the operator executes the preceding steps in reverse order. Specifically, the operator pushes the handle end 114 and/or the elongated frame 112 towards the support surface 122, the operator rotates the working device 118 to its upright, metastable position, and the operator raises the handle end 114 of the frame 112 until the sanding pad 138 contacts the support surface 122. The operator then rotates the locking member 174 until the locking member arms 178 are free to slide about the frame 112. The operator finally slides the locking member 174 towards the work end 116 and rests the ends of the locking member arms 178 against the top of the housing 130. When the arms 178 rest against the housing 130, the locking member 174 prevents the working device 118 from rotating. For example, if the operator pushes the handle end 114 down, thereby raising the work end 116, the working device 118 will be lifted off the support surface 122 but will not be able to rotate about the pivot ears 132.

Turning now to FIG. 9, an alignment tool 180 for aligning an abrasive pad 138 on a sanding apparatus, such as the sanding apparatus 110, the sanding apparatus including a rotatable backing pad 136, is useful for installing sanding/abrasive pads on the sanding apparatus. The tool 180 includes a T-shaped handle 182 and three elongated locating pins 184. The locating pins 184 extend from a surface 186 of the T-shaped handle 182 and are spacedly disposed on the handle. The locating pins 184 are insertable into apertures 188 in the abrasive pad 138 and apertures 190 in the backing pad 136.

The apertures 188, 190 of the abrasive and backing pads must be aligned so that surface particles and sanding waste can be sucked up by the suction means via the tubing 168 and the housing 130. The abrasive pad 138 and the backing pad 136 may have an identical pattern of apertures. The apertures 188, 190 of the abrasive pad 138 and the backing pad 136 may be lined up with the use of the alignment tool 180. First, the three locating pins 184 are received by three apertures 188 in the abrasive pad 138. Then, with the locating pins 184 placed through apertures 188 in the abrasive pad 138, the locating pins 184 are inserted into three apertures 190 of the backing pad 190 corresponding in location to the three apertures of the abrasive pad that received the locating pins. Optionally, an intermediate disc (not shown) may be placed between the backing pad 136 and the abrasive pad 138. The intermediate disc has slots for receiving the locating pins 184. The intermediate disc prevents the abrasive pad 138 from inadvertently sticking to or “bunching up” on attachment means of the backing pad 136, for example hooks or loops of a hook and loop attachment means. Next, the abrasive pad 138 is smoothly engaged with the backing pad 136. In the case that an intermediate disc is employed, the intermediate disc may be slowly removed while the abrasive pad 138 is simultaneously engaged with the backing pad 136. After the abrasive pad 138 is smoothly engaged with the backing pad 136, the alignment tool 180 is removed by pulling the locating pins 184 out of the apertures 188, 190 of the abrasive pad 138 and the backing pad 136. The apertures 188, 190 of the abrasive pad 138 and the backing pad 136 are thereby perfectly aligned.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.
What is claimed is:

1. A sanding apparatus for sanding a support surface comprising:
an elongated frame having a handle end and a work end;
said handle end being arranged for operator control;
said work end being adapted for connection to a working device; and
a stabilizer member adapted to contact and grip the support surface, said stabilizer member being disposed between said handle end and said work end;
wherein said stabilizer member prevents the sanding apparatus from pulling away from an operator during use.

2. The sanding apparatus of claim 1, wherein said stabilizer member includes at least one circular rotating member mounted thereon.

3. The sanding apparatus of claim 2, wherein said circular rotating member includes a peripherally disposed friction layer.

4. The sanding apparatus of claim 3, wherein said friction layer is a rubber-like material.

5. The sanding apparatus of claim 2, wherein said circular rotating member is weighted.

6. The sanding apparatus of claim 2, wherein said stabilizer member includes a plurality of adjacent circular rotating members; and
anti-friction washers separating said circular rotating members.

7. The sanding apparatus of claim 1, wherein said elongated frame is universally rotatable about said stabilizer member.

8. The sanding apparatus of claim 1, wherein said working device is operatively, pivotally connected to said work end of said elongated frame.

9. The sanding apparatus of claim 8, further including a locking member for locking said working device into an operative position on said elongated frame.

10. The sanding apparatus of claim 1, wherein said handle end includes a handle, said handle being universally rotatable about said elongated frame.

11. The sanding apparatus of claim 1, wherein said working device includes a housing and at least one side-wheel extendedly mounted to said housing.

12. The sanding apparatus of claim 1, wherein said working device includes a backing pad, said backing pad being of a ring-like shape.

13. The sanding apparatus of claim 1, wherein said elongated frame is at least partially tubular to allow for communication of sanding waste.

14. The sanding apparatus of claim 1, wherein said sanding apparatus includes a pair of receivers disposed at said work end of said elongated frame; and
a stand including:
two elongated engagement members receivable in said receivers, said engagement members being generally parallel to each other;
a leg extending from each engagement member generally perpendicular to said engagement members, each of said legs being disposed generally centrally along the engagement member from which it extends; and
a brace member connected to said legs at ends of said legs.

15. A sanding apparatus for sanding a support surface comprising:
an elongated frame having a handle end and a work end;
a working device including a housing, two opposing pivot ears extending from said housing, at least one side-wheel extendedly mounted to said housing, a motor mounted on said housing, and a backing pad operatively connected to said motor;
said working device being operatively connected to said work end of said elongated frame by said pivot ears;
said handle end of said frame including a handle and controls for controlling said working device;
said frame further including a stabilizer member adapted to contact and grip the support surface, said stabilizer member being disposed between said handle end and said work end;
said stabilizer member including at least one circular rotating member mounted thereon.

16. A method for sanding a support surface comprising the step of:
providing a sanding apparatus including:
an elongated frame having a handle end and a work end;
said handle end being arranged for operator control;
said work end being adapted for connection to a working device; and
a stabilizer member adapted to contact and grip the support surface, said stabilizer member being disposed between said handle end and said work end of said frame;
wherein said stabilizer member prevents the sanding apparatus from pulling away from an operator during use.

17. The method of claim 16, wherein said stabilizer member includes a circular rotating member mounted thereon.

18. The method of claim 17, wherein said circular rotating member is weighted.

19. An alignment tool for aligning an abrasive pad on a sanding apparatus including a rotatable backing pad, said tool comprising:
a T-shaped handle; and
three elongated locating pins;
said locating pins extending from a surface of said T-shaped handle and being spacedly disposed on said handle;
wherein said locating pins are insertable into apertures in the abrasive pad and backing pad.
